(19) United States
(12) Patent Application Publication
(10) Pub. No.: US 2013/0055298 A1
(43) Pub. Date: Feb. 28, 2013

(54) INFORMATION RECORDING MEDIUM AND METHOD FOR PRODUCING SAME, AND INFORMATION RECORDING MATERIAL

(71) Applicants: Kouki Hatsuda, Tochigi (JP); Kyungsung Yun, Tochigi (JP)

(72) Inventors: Kouki Hatsuda, Tochigi (JP); Kyungsung Yun, Tochigi (JP)

(73) Assignee: Sony Chemical & Information Device Corporation, Tokyo (JP)

(21) Appl. No.: 13/638,492

(22) PCT Filed: Jun. 9, 2011
(86) PCT No.: PCT/JP2011/063285

§ 371 Date: Sep. 28, 2012

(30) Foreign Application Priority Data
Jun. 10, 2010 (JP) 2010-132839

(51) Int. Cl. G11B 7/24

(52) U.S. Cl. 720/718; G9B/7.166

(57) ABSTRACT

An information recording medium excellent in long storage and capable of high-density recording, method of manufacturing the information recording medium, and information recording material are provided. Pulse laser light is focused onto a recording layer in which a thermosetting epoxy resin having a skeleton with high planarity and a curing agent are polymerized to form a recording mark. With a molecular weight between cross-linking points of a cured material of the recording layer being set to be equal to or smaller than 2000 and, more preferably, equal to or smaller than 500, a distance between recording marks (cavities) can be shortened.

### FIELD OF THE INVENTION

This invention relates to an information recording medium where information is recorded with high-intensity pulse laser light and method of manufacturing the information recording medium, and information recording material. The present application claims priority rights to JP Patent Application 2010-132839 filed in Japan on Jun. 10, 2010, which is hereby incorporated by reference.

### BACKGROUND OF THE INVENTION

As a next-generation optical disc recording method, technologies have been disclosed in which recording light is focused to form recording marks made of cavities near a focus of the recording light (for example, refer to PTL 1 to PTL 3). In these recording methods, a CW (Continuous Wave) laser is used as a light source. Therefore, an information recording material contains a highly photosensitive material in photothermal mode, such as a photosensitizer or a photo-acid-generating agent.

### PRIOR-ART DOCUMENTS

### Patent Documents

PTL 1: Japanese Patent Application Laid-Open No. 2009-59404

PTL 2: Japanese Patent Application Laid-Open No. 2010-15631

PTL 3: Japanese Patent Application Laid-Open No. 2010-15632

### SUMMARY OF THE INVENTION

In the recording methods described above, since the information recording medium contains a large amount of the highly photosensitive material in photothermal mode, photothermal degradation is severe. In long storage for fifty years or so, the recording marks are potentially lost.

The present invention is suggested in view of these realities, and provides an information recording medium excellent in long storage and capable of high-density recording, method of manufacturing the information recording medium, and information recording material.

As a result of diligent studies, the inventors have found that, by adopting laser ablation with high peak power pulse laser to make the void marks and by adopting recording material which is thermo-curable epoxy resin with high crosslinking density and high packing density (high planarity), the medium can be excellent in long archive life and shelf life and high density recording.

That is, an information recording medium according to the present invention has a recording layer whose material is made of epoxy resin polymerized with a monomer having two or more benzene rings by curing agent wherein a recording mark is to be formed or has been formed in the recording layer.

Also, an information recording medium according to the present invention has a recording layer whose material is made of epoxy resin polymerized with a monomer having two or more benzene rings by curing agent between transparent substrate to form a recording layer.

Furthermore, an information recording medium according to the present invention has a recording layer whose material is made of epoxy resin polymerized with a monomer having two or more benzene rings by curing agent.

### EFFECTS OF THE INVENTION

According to the present invention, since a large amount of the highly photosensitive material such as a photosensitizer or a photo-acid-generating agent in photothermal mode is not contained in the recording layer, a high degree of reliability can be obtained for long storage. Also, since the recording layer is formed with high density from a thermosetting epoxy resin having a skeleton with high planarity, recording marks can be formed with high density by concentrating recording light.

### BRIEF DESCRIPTION OF DRAWINGS

FIG. 1 is a schematic view of a recording method in an embodiment of the present invention.

FIG. 2 is a graph showing a relation between a molecular weight between cross-linking points and a minimum recording pitch.

FIG. 3A depicts an FIB-SEM image when recording marks are formed on an information recording medium of Sample 1 with a recording pitch of 325 nm.

FIG. 3B is a schematic view of an FIB-SEM image when recording marks are formed on an information recording medium of Sample 1 with a recording pitch of 325 nm.

FIG. 4A depicts an FIB-SEM image when recording marks are formed on an information recording medium of Sample 3 with a recording pitch of 275 nm.

FIG. 4B is a schematic view of an FIB-SEM image when recording marks are formed on an information recording medium of Sample 3 with a recording pitch of 275 nm.

FIG. 5A depicts an FIB-SEM image when recording marks are formed on an information recording medium of Sample 4 with a recording pitch of 225 nm.

FIG. 5B is a schematic view of an FIB-SEM image when recording marks are formed on an information recording medium of Sample 4 with a recording pitch of 225 nm.

FIG. 6A depicts an FIB-SEM image when recording marks are formed on an information recording medium of Sample 6 with a recording pitch of 275 nm.

FIG. 6B is a schematic view of an FIB-SEM image when recording marks are formed on an information recording medium of Sample 6 with a recording pitch of 275 nm.

### DETAILED DESCRIPTION OF THE INVENTION

Embodiments of the present invention are described in detail below in the following order with reference to the drawings.

1. Summary of Recording Method

2. Information Recording Medium

3. Examples

<1. Summary of Recording Method>

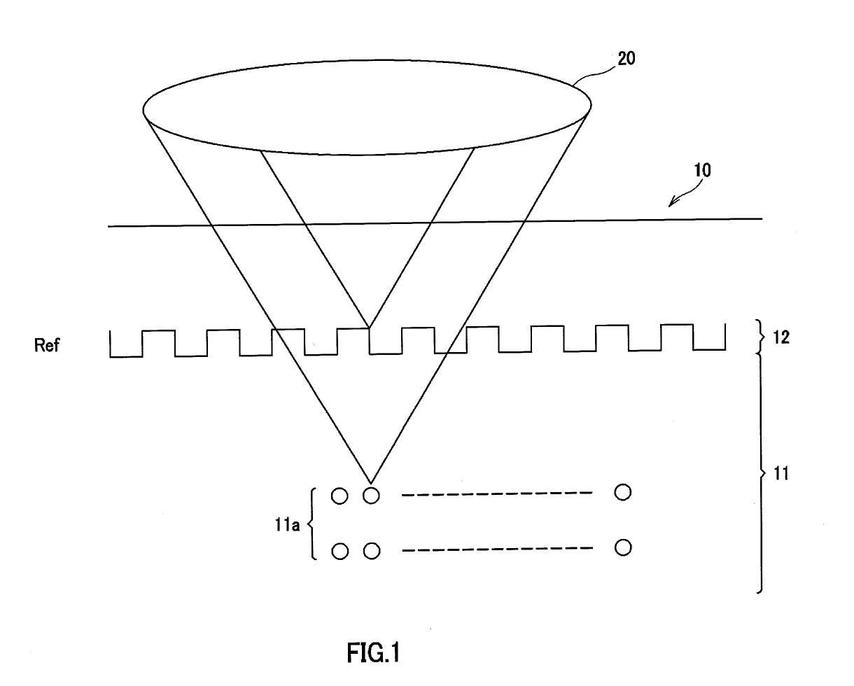

FIG. 1 is a schematic view of a recoding method in an embodiment of the present invention. In the recording method in the present embodiment, by laser abrasion with pulse laser light, recording marks 11a formed of cavities are formed on a recording layer 11 of an information recording medium 10.

As a light source of pulse laser light, the one capable of oscillating high-intensity pulses with a pulse width equal to or smaller than 1 nsec can be used. Examples of this light source include a semiconductor laser made of GaInN or others disclosed in Applied Physics Letters 93, 131113 (2008) and others and a solid laser such as a titanium: sapphire laser (hereinafter abbreviated as a Ti:S laser).

The pulse laser light is focused by an objective lens 20 onto a predetermined position on the recording layer 11. With material vaporization by laser abrasion, the recording marks 11a made of cavities are formed on the recording layer 11. Note that the recording marks 11a are formed at a three-dimensionally accurate position by using, for example, a guide pattern 12 formed on a glass substrate.

As such, by forming recording marks by using laser abrasion, a photosensitizer, a photo-acid-generating agent, or the like does not have to be contained in the recording layer 11. Therefore, the possibility of loss of recording marks is decreased, thereby obtaining a high degree of reliability for long storage.

### <2. Information Recording Medium>

Next, the structure of the information recording medium in an embodiment of the present invention is described. The information recording medium represented as a specific example functions as a so-called medium for recording information by forming a recording layer between substrates. The shape of the information recording medium is not particularly restrictive, and the information recording medium may be formed in a rectangular plate shape or, like an optical disc such as BD (Blu-ray Disc, registered trademark) or DVD (Digital Versatile Disc), in a disc shape having a diameter of 120 mm and having a hole for chucking at the center.

The recording layer is formed of a cured material in which a thermosetting epoxy resin having a skeleton with high planarity and a curing agent are polymerized. Examples of the skeleton with high planarity include a naphthalene skeleton (A), a fluorene skeleton (B), an anthracene skeleton (C), a bisphenol A skeleton (D), and a biphenyl skeleton (E), which have two or more benzene rings in a molecule of any of monomers represented in General Formulas (A) to (E) below.

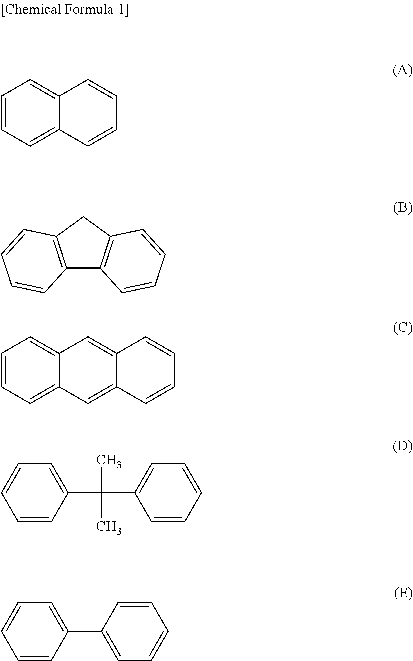

Also, the number of functional groups of the epoxy resin (pre-monomer) (an average number of epoxy groups per molecule) is desirably two or more in order to achieve high-density three-dimensional cross-linking. Specific examples of the epoxy resin include naphthalene-type bifunctional epoxy resins (“HP4032” and “HP4032D” manufactured by DIC Corporation), a naphthalene-type quatro-functional epoxy resin (“HP4700” manufactured by DIC Corporation), a naphthol-type epoxy resin (“ESN-475V” manufactured by Tohto Kasei Co., Ltd.), fluorene-type epoxy resins (“ONCOAT 1020”, “ONCOAT 1012”, and “ONCOAT 1040” manufactured by Nagase Chemte x Corporation and “OGSOL EG” manufactured by Osaka Gas Chemicals Co., Ltd.), liquid bisphenol-A-type epoxy resins (“830 CRP” manufactured by DIC Corporation and “EPICOAT 828EL” (“jER 828EL”) manufactured by Japan Epoxy Resins Co., Ltd.), biphenyl-type epoxy resins (“NC3000H” and “NC3000L” manufactured by Nippon Kayaku Co., Ltd. and “YX4000” manufactured by Japan Epoxy Resins Co., Ltd.), and an anthracene-analogous-type epoxy resin (“YX8800” manufactured by Japan Epoxy Resins Co., Ltd). Any one of these epoxy resins may be used alone or two or more of these epoxy resins may be used in combination.

The curing agent is not particularly restrictive as long as it sufficiently achieves the effects of the present invention, and any of an amine compound, sulfonate, iodonium salt, imidazoles, and acid anhydrides (phthalic acid, phthalic anhydride, and hexahydrophthalic anhydride) can be used. One or two or more curing agents can be used singly or in combination. Also, the amount of curing agent in the epoxy resin composite is normally 0.1 phr (Per Hundred Resin) to 10 phr.

This cured material with the epoxy resin and the curing agent polymerized is formed of an epoxy resin having two or more benzene rings in a molecule of a monomer. Therefore, steric hindrance is small, and three-dimensional crosslinks are established with high density. That is, the epoxy resin cured material in the present embodiment has a large crosslink density and a small molecular weight between cross-linking points indicative of sparseness or denseness of cross-links.

The molecular weight between cross-linking points of the epoxy resin cured material in the present embodiment is preferably equal to or smaller than 2000 and, more preferably, equal to or smaller than 500. As the molecular weight between cross-linking points is smaller (as cross-links are denser), the modulus of rigidity is higher, thereby decreasing the distance between recording marks (cavities).

The molecular weight between cross-linking points is calculated from the following Flory equation.

Mc=3ρRT/E′

Here, Mc=molecular weight between cross-linking points, ρ=density, T=temperature, R=gas constant, and E′=minimum value of a storage elastic modulus in a high-temperature region.

In the method of manufacturing the information recording medium in the present embodiment, a thermosetting epoxy resin having the flat skeleton described above and a curing agent are polymerized between transparent substrates to form a recoding layer. Specifically, a transparent substrate such as glass or polycarbonate is coated with the epoxy resin and the curing agent of a predetermined thickness, and another transparent substrate is placed thereon for interposing. Then, the epoxy resin and the curing agent are subjected heat polymerization and crosslink curing by an oven or the like. With this, an information recording medium having a recording layer can be manufactured.

<3. Examples>

Examples of the present invention are described below. Here, recording marks were written with a pulse laser onto fabricated information recording media of Sample 1 to Sample 6, and minimum recording pitches were evaluated. Note that the present invention is not restricted to these examples.

[Sample 1]

To a bifunctional naphthalene-type epoxy resin (product name: HP-4032D, manufactured by DIC Corporation) represented by Compound 1 below, 0.5 phr of tris(dimethylaminomethyl)phenol (product name: DMP-30, manufactured by Kanto Chemical Co., Inc.) represented by Compound 2 below as a curing agent was added for mixing and deaerating. This mixture liquid was applied onto a cover glass substrate having a thickness of 0.15 mm, the mixture liquid being adjusted so as to have a thickness of 0.25 mm. Then, a glass substrate having a thickness of 0.75 mm was placed thereon for interposing. This entire test sample was left in an oven at 80° C. for twelve hours for heat polymerization and crosslink curing of the mixture liquid, thereby fabricating the information recording medium of Sample 1.

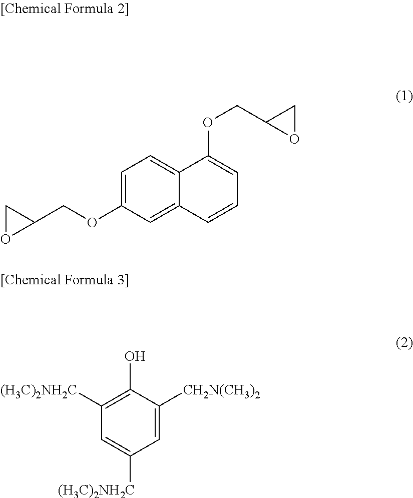

[Sample 2]

The information recording medium of Sample 2 was fabricated under conditions similar to those of Sample 1 except that the amount of addition of tris (dimethylaminomethyl) phenol (product name: DMP-30, manufactured by Kanto Chemical Co., Inc.) was set at 1.0 phr.

[Sample 3]

The information recording medium of Sample 3 was fabricated under conditions similar to those of Sample 3 except that the amount of addition of tris (dimethylaminomethyl) phenol (product name: DMP-30, manufactured by Kanto Chemical Co., Inc.) was set at 2.0 phr.

[Sample 4]

The information recording medium of Sample 4 was fabricated under conditions similar to those of Sample 1 except that, in place of tris(dimethylaminomethyl)phenol (product name: DMP-30, manufactured by Kanto Chemical Co., Inc.), 2.0 phr of a special amine-based curing agent (product name: U-Cat 18X, manufactured by San-Apro Ltd.) was added.

[Sample 5]

Polyarylate powder (product name: M1000, manufactured by UNITIKA Ltd.) was interposed between a cover glass substrate having a thickness of 0.15 mm and a glass substrate having a thickness of 0.75 mm so as to have a thickness of 0.25 mm, and heat pressing was performed, thereby generating the information recording medium of Sample 5.

[Sample 6]

The information recording medium of Sample 6 was fabricated under conditions similar to those of Sample 5 except that polyarylate powder (product name: M9000, manufactured by UNITIKA Ltd.) was used.

<Measurement of Molecular Weight between Cross-linking Points>

A minimum value of a storage elastic modulus E′ of each of the cured materials of Sample 1 to Sample 4 in a high-temperature region was measured by a dynamic viscoelasticity measurement apparatus (DMA: Dynamic Mechanical Analysis) (product name: RSA-3, manufactured by TA Instruments). Also, a density p of each of the cured materials of Sample 1 to Sample 4 was measured by a dry-type density measurement apparatus (product name: ACUPIC 1330 manufactured by Shimadzu Corporation).

Then, a molecular weight between cross-linking points Mc of each of Sample 1 to Sample 4 was calculated from the following Flory equation.

Mc=3ρRT/E′

Here, Mc=molecular weight between cross-linking points, ρ=density, T=temperature, R=gas constant (8.314 J/K·mol), and E′=minimum value of a storage elastic modulus in a high-temperature region.

<Write Recording Evaluations>

A fundamental wave of 800 nm (pulse width: 2.2 psec) of a Ti:S laser (manufactured by Coherent, Inc.) was converted to a second harmonic generation of 405 nm to generate pulse trains. A shutter of an electrooptic (EO) element was opened and closed to control irradiation of the pulse trains only for a predetermined time, and light passing through the EO element was focused onto the information recording medium by a microscopic objective lens (NA 0.85) (objective out: power of 170 W, repetition frequency: 76 MHz), thereby forming recording marks. Also, a photodiode was connected to an oscilloscope to monitor whether the shutter normally operated. Also, the movement of the information recording medium was strictly controlled by an XY stage using a piezo element,

For writing, irradiation was performed for a minimum exposure time required to allow formation of marks, and three recording marks were formed with arbitrary recording distances (pitches).

For reading, a 405-nm semiconductor laser was coaxially aligned to detect returned light from an any mark by raster scanning with reconstructive light with the strict movement of the XY stage, thereby obtaining an image. In that image, a minimum distance between recording marks where mark isolation was recognized was taken as a minimum recording pitch.

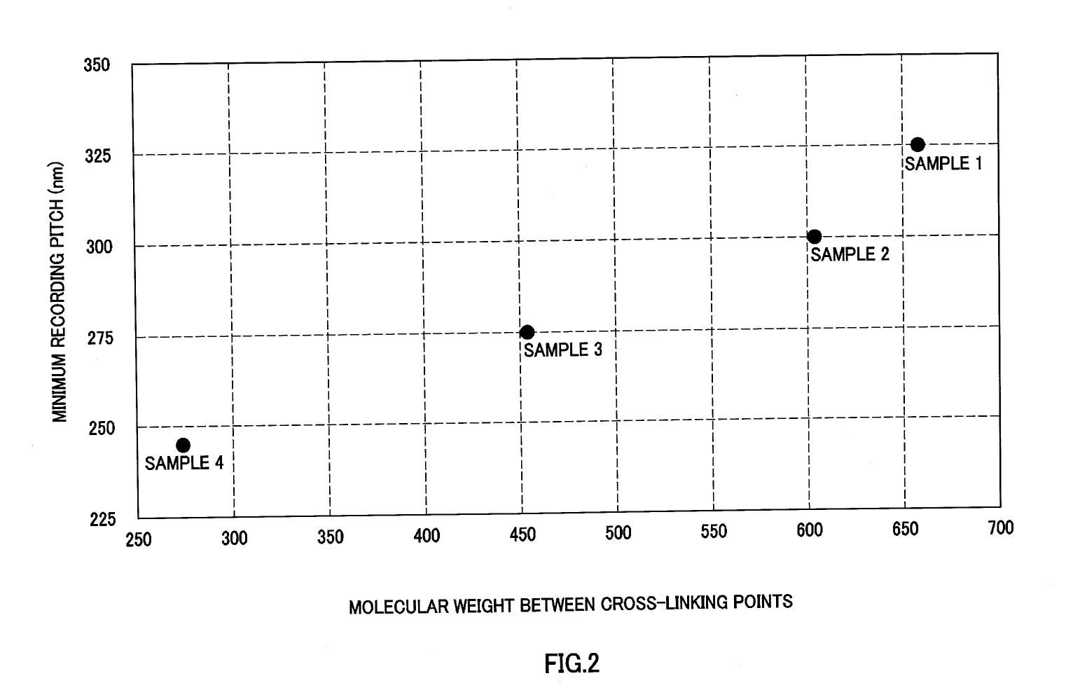

Table 1 depicts evaluation results of recording pitches of Sample 1 to Sample 6. The one where mark isolation was recognized is indicated by ◯, and the one where mark isolation was not recognized is indicated by ×. Also, FIG. 2 depicts a graph showing a relation between a molecular weight between cross-linking points and a minimum recording pitch.

TABLE 1

| | | CURING | AMOUNT | | RECORDING PITCH (nm) | | | | | | | |
|---|---|---|---|---|---|---|---|---|---|---|---|---|
| SAMPLE | RESIN | AGENT | (phr) | Mc | 400 | 375 | 350 | 325 | 300 | 275 | 250 | 225 |
| 1 | 4032D | DMP-30 | 0.5 | 660 | ∘ | ∘ | ∘ | ∘ | x | x | x | — |
| 2 | 4032D | DMP-30 | 1.0 | 600 | ∘ | ∘ | ∘ | ∘ | ∘ | x | — | — |
| 3 | 4032D | DMP-30 | 2.0 | 450 | ∘ | ∘ | ∘ | ∘ | ∘ | ∘ | x | — |
| 4 | 4032D | U-Cat18X | 2.0 | 274 | — | — | — | — | ∘ | ∘ | ∘ | ∘ |
| 5 | M1000 | — | — | — | x | — | — | — | x | — | x | — |
| 6 | M9000 | — | — | — | ∘ | — | — | — | x | — | x | — |

As depicted in FIG. 2, it has been found that as the molecular weight between cross-linking points is smaller (as cross-links are denser), the recording pitch can be decreased. In particular, it has been found that according to a recording layer having a molecular weight between cross-linking points equal to or smaller than 500, recording marks can be formed with a recording pitch equal to or smaller than 300 nm and massive data of 6 GB per layer can be recorded in a mark position method.

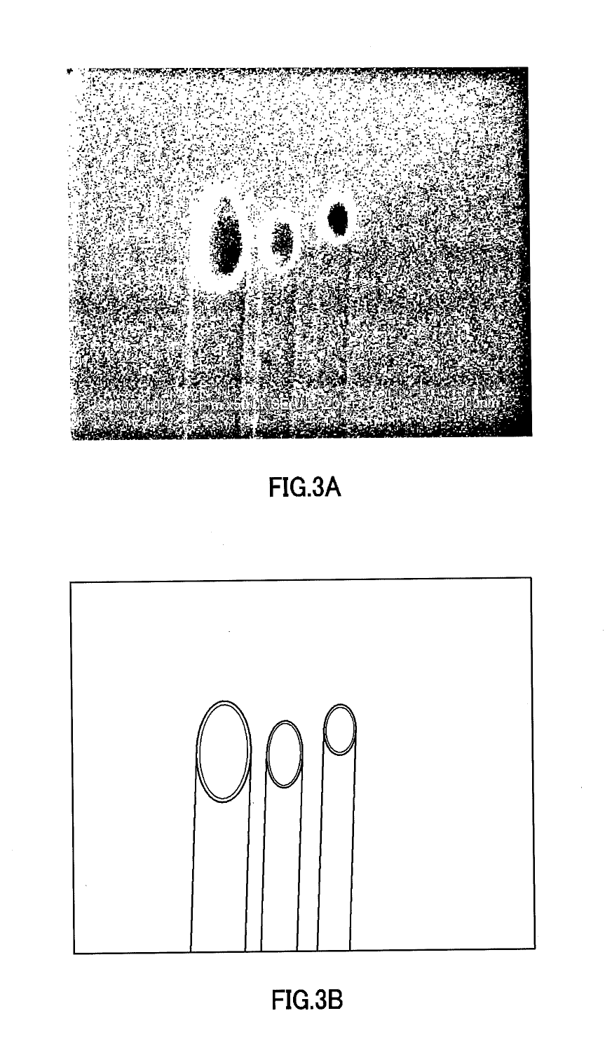

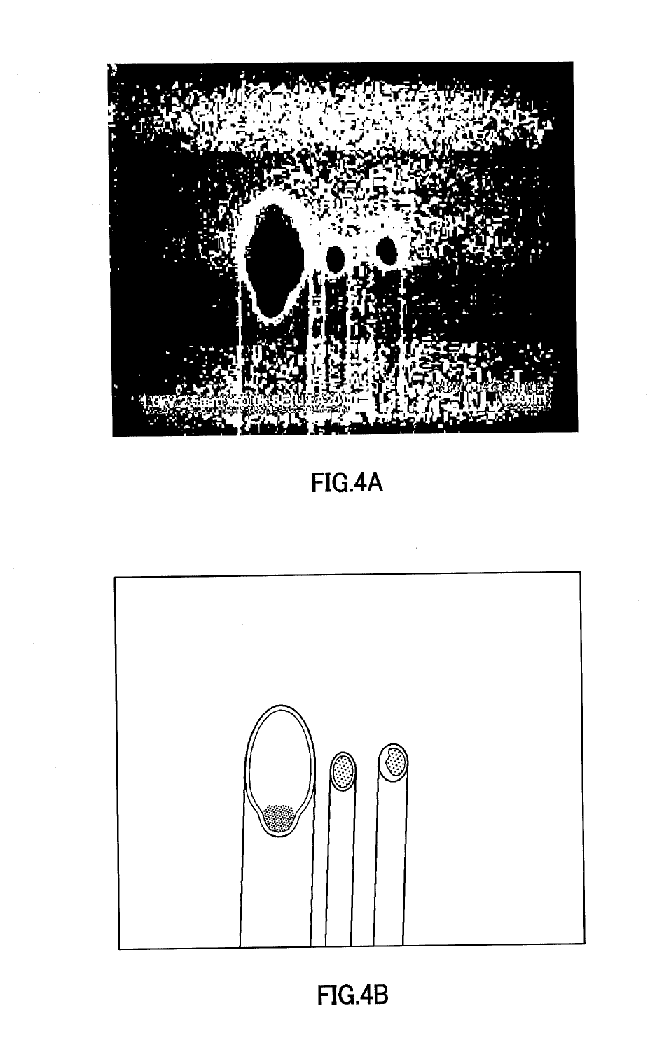

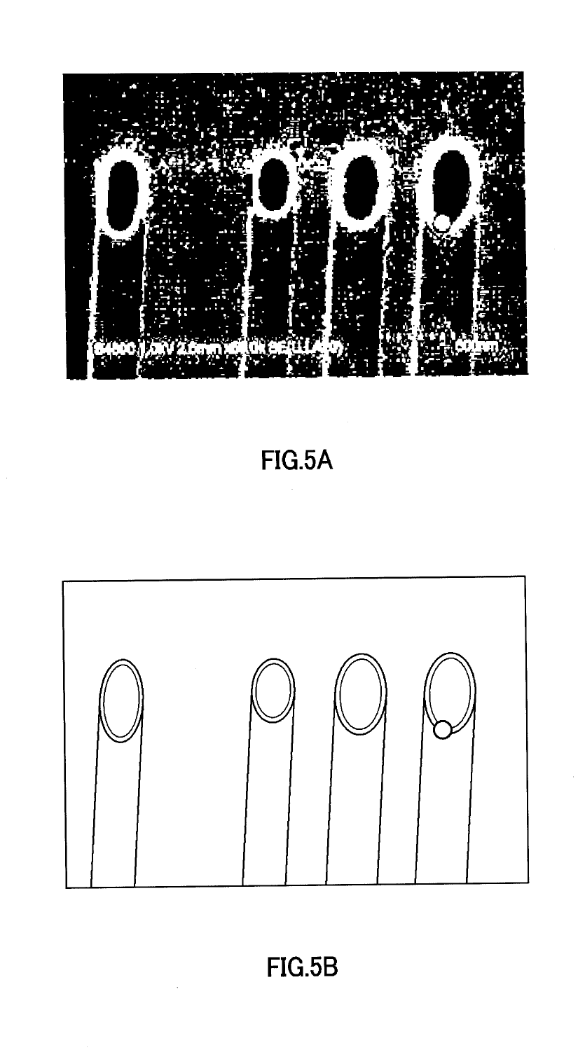

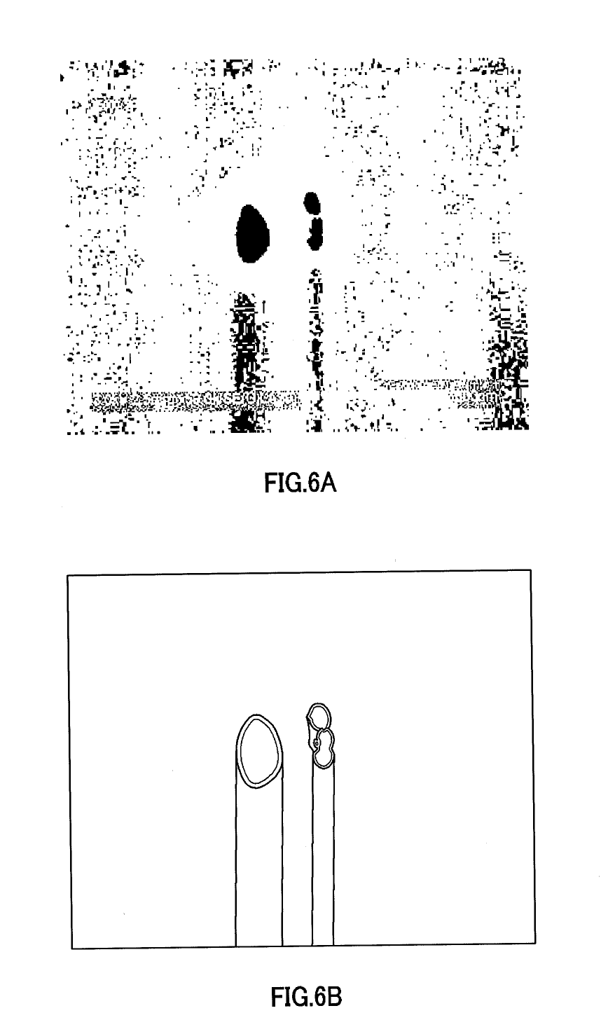

Furthermore, FIG. 3A to FIG. 6A each depict a SEM (Scanning Electron Microscope) image by FIB (Focused Ion Beam) process on the recording marks. Also, FIG. 3B to FIG. 6B are schematic views of the SEM images depicted in FIG. 3A to FIG. 6A, respectively. Here, FIG. 3A and FIG. 3B are when recording marks are formed on the information recording medium of Sample 1 with a recording pitch of 325 nm, FIG. 4A and FIG. 4B are when recording marks are formed on the information recording medium of Sample 3 with a recording pitch of 275 nm, FIG. 5A and FIG. 5B are when recording marks are formed on the information recording medium of Sample 4 with a recording pitch of 225 nm, and FIG. 6A and FIG. 6B are when recording marks are formed on the information recording medium of Sample 6 with a recording pitch of 275 nm.

In the FIB-SEM image depicted in FIG. 6A, since a thermosetting resin was used in the recording layer, when recording marks were formed with a recording pitch of 225 nm, recording marks were attached together, and mark isolation was not able to be recognized. On the other hand, in the FIB-SEM images depicted in FIG. 3A to FIG. 5A, mark isolation was able to be recognized even when the recording pitch was smaller as the molecular weight between cross-linking points of the recording layer was smaller. That is, it has been found that, by decreasing the molecular weight between cross-linking points, the recording mark diameter can be decreased and the recording pitch can be decreased.

Also, by decreasing the molecular weight between cross-linking points, signal characteristics were able to be improved. Specifically, when a reproduced signal with mark position recording on a disc having an epoxy resin with a molecular weight between cross-linking points equal to or smaller than 500 as a recording material, an excellent CNR (Carrier Noise Ratio) was able to be obtained.

### REFERENCE SIGNS LIST

10 . . . information recording medium, 11 . . . recording layer, 12 . . . guide pattern, 20 . . . objective lens

1. An information recording medium comprising a recording layer in which an epoxy resin having two or more benzene rings in a molecule and a curing agent are polymerized, wherein
a recording mark is to be formed or has been formed in the recording layer.

2. The information recording medium according to claim 1, wherein
the epoxy resin has at least one of a naphthalene skeleton, a fluorene skeleton, an anthracene skeleton, a bisphenol A skeleton, and a biphenyl skeleton.

3. The information recording medium according to claim 1, wherein
the recording layer has a molecular weight between cross-linking points equal to or smaller than 500.

4. The information recording medium according to claim 1, wherein
pulse laser light focused onto the recording layer has a peak power equal to or larger than 1 W and a pulse width equal to or smaller than 1 ns.

5. An information recording medium manufacturing method of polymerizing, between transparent substrates, an epoxy resin having two or more benzene rings in a molecule and a curing agent to form a recording layer.

6. An information recording material in which an epoxy resin having two or more benzene rings in a molecule and a curing agent are polymerized.

7. The information recording medium according to claim 2, wherein
the recording layer has a molecular weight between cross-linking points equal to or smaller than 500.

8. The information recording medium according to claim 2, wherein
pulse laser light focused onto the recording layer has a peak power equal to or larger than 1 W and a pulse width equal to or smaller than 1 ns.

9. The information recording medium according to claim 3, wherein
pulse laser light focused onto the recording layer has a peak power equal to or larger than 1 W and a pulse width equal to or smaller than 1 ns.
